(19) United States
(12) Patent Application Publication
(10) Pub. No.: US 2015/0078816 A1
(43) Pub. Date: Mar. 19, 2015

(54) FASTENING DEVICE, AND ASSEMBLY COMPRISING AN APPARATUS OR A BODY AND A TOP-HAT RAIL

(71) Applicant: STEGO-HOLDING GMBH, Schwaebisch Hall (DE)

(72) Inventor: Robert Dent, Schwaebisch Hall (DE)

(21) Appl. No.: 14/396,710

(22) PCT Filed: Apr. 24, 2013
(86) PCT No.: PCT/EP2013/058422

§ 371 Date: Oct. 23, 2014

(30) Foreign Application Priority Data
Apr. 24, 2012 (DE) 10 2012 103 582.2

(51) Int. Cl. F16B 21/08; F16B 21/06

(52) U.S. Cl. CPC F16B 21/08; F16B 21/06
USPC 403/348

(57) ABSTRACT

A fastening device for fastening an apparatus or a body by means of its rear wall to a top-hat rail containing a first upper and a first lower holding device, the first upper holding device engaging around an upper edge of the top-hat rail in the fastened state and the first lower holding device engaging around a lower edge of the top-hat rail in the fastened state, the first upper holding device being in a resilient form such that the apparatus or the body can be inserted into the top-hat rail by being tilted in an insertion tilt direction about a tilt axis running parallel to the longitudinal direction of the top-hat rail.

The invention relates to a fastening device according to the precharacterising clause of claim 1 and to an arrangement according to claim 11.

Mounting rails are used in electrical engineering in a large number of different devices, for fastening components. A particular type of mounting rail is a top-hat rail, which is used in particular in switching cabinets and switching boxes. A large number of fastening devices for fastening components to such a top-hat rail are known.

A disadvantage of fastening devices known hitherto for fastening pieces of equipment or bodies, that is to say components, to top-hat rails is that they are technically very complex. In particular the operation of attaching to the top-hat rail itself is complicated and laborious to carry out.

Accordingly, the object of the present invention is to provide a fastening device for fastening an apparatus or body by means of its rear wall to a top-hat rail, which fastening device is of technically simple construction.

The object is achieved by a fastening device according to patent claim 1.

In particular, the object is achieved by a fastening device for fastening an apparatus or a body by means of its rear wall to a top-hat rail, comprising a first upper and a first lower holding device, the first upper holding device engaging around an upper edge of the top-hat rail in the fastened state and the first lower holding device engaging around a lower edge of the top-hat rail in the fastened state, the first upper holding device being in a resilient form such that the apparatus or the body can be inserted into the top-hat rail by being tilted in an insertion tilt direction about a tilt axis running parallel to the longitudinal direction of the top-hat rail. It is advantageous here that the fastening device is of technically simple construction. A further advantage is that the fastening device is inexpensive to produce. In addition, the fastening of an apparatus or a body by means of its rear wall to a top-hat rail by means of such a fastening device is simple to carry out; in particular, fastening can be carried out using only one hand. Moreover, only a small amount of space is required around the top-hat rail, in particular above the upper edge and beneath the lower edge of the top-hat rail, for fastening an apparatus or a body to a top-hat rail by means of such a fastening device. Also, only a small amount of space is required on the top-hat rail itself for the fastening of the apparatus or of the body. It is also advantageous that the apparatus or the body can be detached from the top-hat rail again in a technically simple manner; in particular, this can also be carried out using only one hand.

The first upper holding device can be connected, in particular directly, to the rear wall. A particularly secure connection between the rear wall and the top-hat rail is thereby achieved. In addition, the technical construction of the fastening device is even simpler.

In one embodiment, the fastening device further comprises a second upper holding device and a second lower holding device, the second upper holding device being substantially identical with the first upper holding device and the second lower holding device being substantially identical with the first lower holding device. An advantage of this is that the apparatus or the body can be fastened to the top-hat rail in a second orientation or position. Several possibilities for the orientation or positioning of the apparatus/body are thus available. In this manner, particularly good use can be made of the space available on or around the top-hat rail.

In a further embodiment, the second upper holding device is arranged substantially perpendicular to the first upper holding device, and the second lower holding device is arranged substantially perpendicular to the first lower holding device. This has the advantage that the apparatus or the body can be fastened to the top-hat rail in two arrangements or orientations/positions which are at an angle of about 90° to one another. In this manner, even better use can be made of the space available on the top-hat rail or around the top-hat rail. In addition, the orientation or arrangement of the apparatus or body can thereby be correspondingly adapted to prevailing conditions.

In a further embodiment, the first and/or the second upper holding device comprises a spring-like snap hook. This has the advantage that fastening is even simpler to carry out. By simply arranging the first and/or second lower holding device so that it engages around the lower edge of the top-hat rail, tilting the apparatus or the body in an insertion tilt direction and simply pressing the fastening device against the top-hat rail, the spring-like snap hook snaps into place and engages around the upper edge of the top-hat rail. In addition, the technical construction of the fastening device is even simpler.

In a further embodiment, the first upper holding device and/or the first lower holding device and/or the second upper holding device and/or the second lower holding device are formed integrally with the rear wall of the apparatus or of the body, in particular are made of plastics material, preferably injection moulded. An advantage thereof is that the fastening device is even more inexpensive to produce. A further advantage is that the fastening device, or the holding device(s) of the fastening device, are particularly stable. In addition, the technical construction of the fastening device is even simpler.

The first upper holding device can have a width which is smaller than the distance between the second upper holding device and the second lower holding device, and/or the second upper holding device can have a width which is smaller than the distance between the first upper holding device and the first lower holding device. It is thus ensured that the upper holding device that is not in use in the fastened state can be received within the inside dimension, or in the interior, of the top-hat rail. The apparatus or the body can accordingly be fastened to the top-hat rail in a space-saving manner.

In a further embodiment, the rear wall is free of inserts along an imaginary prolongation of a front edge of the first upper holding device and along an imaginary prolongation of a front edge of the second upper holding device. This has the advantage of ensuring that no inserts or structural elements of the other holding device that is not in use in the fastened state interfere with the attachment of the apparatus or of the body. An obstruction during the attachment of the apparatus or the body or the prevention of attachment by the upper holding device that is not in use is reliably avoided in this manner.

The first lower holding device and/or the second lower holding device can comprise three hook-like projections, which in particular are at equal distances from one another. Particularly secure and simple engagement around the lower edge of the top-hat rail is thereby achieved.

The second lower holding device can comprise part of the first lower holding device. This has the advantage that the fastening device is less expensive to produce. In addition, the technical construction of the fastening device is simpler. Moreover, the fastening device occupies less space as a result.

The object is also achieved by an arrangement according to patent claim 11. In particular, the object is achieved by an arrangement comprising an apparatus or a body and a top-hat rail, the apparatus or the body being fastened to the top-hat rail by means of a fastening device according to any one of the preceding claims. This has the advantage that the apparatus or the body is fastened to the top-hat rail by means of a fastening device of technically simple construction. A further advantage is that the fastening device is inexpensive to produce and the arrangement as a whole is accordingly inexpensive to produce. In addition, the fastening of the apparatus or of the body by means of its rear wall can be released from the top-hat rail in a simple manner in this arrangement; in particular, it can be released using only one hand. Moreover, only a small amount of space is required in this arrangement on the top-hat rail or around the top-hat rail for fastening the apparatus or the body to the top-hat rail by means of such a fastening device.

The apparatus that is to be fastened or that is fastened can in particular be a fan. Accordingly, in particular a fan can be fastened to the top-hat rail by means of the fastening device. The fan comprises a nozzle which is fastened to a base plate, the base plate having the fastening device according to the invention on its rear wall. The fan can comprise a one-dimensional pivot element for pivoting the fan about a pivot axis. The direction of the air emerging through the nozzle can thereby be adjusted in a technically simple manner.

The fan can be mounted in positions such that the pivot axis runs substantially parallel or substantially perpendicular to the longitudinal axis of the top-hat rail. A large degree of freedom in terms of the discharge direction of the air through the nozzle of the fan is thereby ensured. If the fan is additionally provided with a rotatable discharge grid, it is thus possible to set any direction of the discharge direction of the air. Owing to the possibility of mounting the fan, by means of the fastening device according to the invention, in two positions that are offset relative to one another by 90°, only a one-dimensional pivot element is required in order to achieve a high or the maximum degree of freedom in terms of the discharge direction of the air. A one-dimensional pivot element, which is pivotable in a single plane, has the advantage, in particular over a two-dimensional pivot element, that it is inexpensive and stable. At the same time, a high or the maximum degree of freedom in terms of the adjustability of the discharge direction is achieved by the combination of mountability in two positions offset relative to one another by 90°, pivotability or rotatability about a pivot axis and optionally owing to the rotatability of the discharge grid. The fan with a one-dimensional pivot element is in particular stable to vibrational forces, or more stable than a two-dimensional rotary element or pivot element when vibrational forces occur, in particular when the second axis of rotation or pivot axis in a two-dimensional rotary element or pivot element is further away from the top-hat rail, that is to say the point of attachment of the fan.

Preferred embodiments will become apparent from the dependent claims. The invention will be described in greater detail below by means of drawings of exemplary embodiments. In the drawings

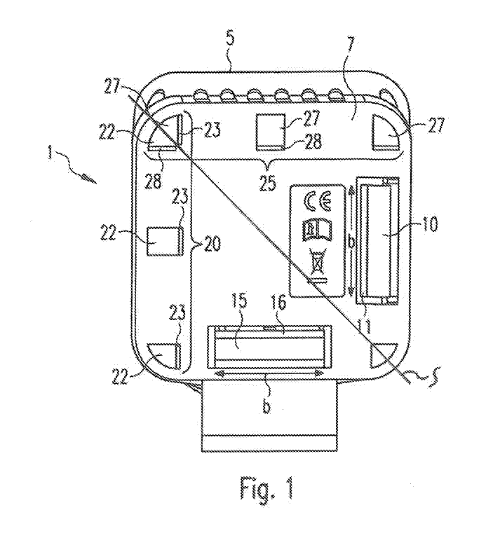

FIG. 1 shows a top view of the rear wall of an apparatus or of a body with an embodiment of the fastening device according to the invention;

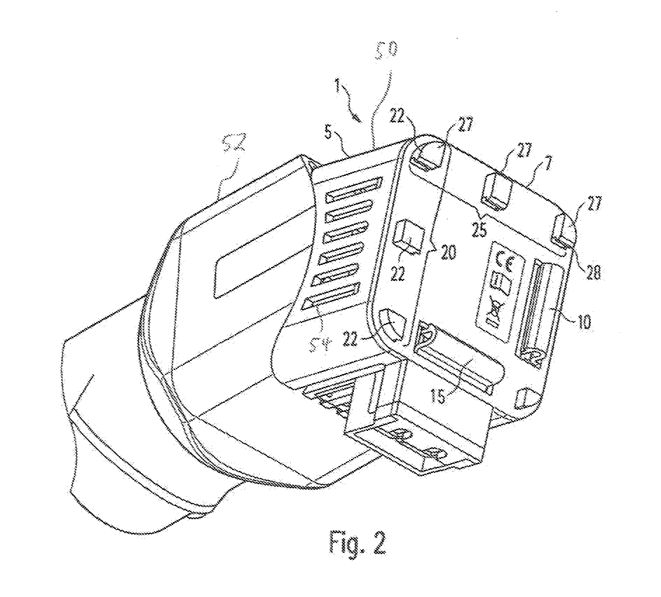

FIG. 2 shows a perspective view of the rear wall of FIG. 1;

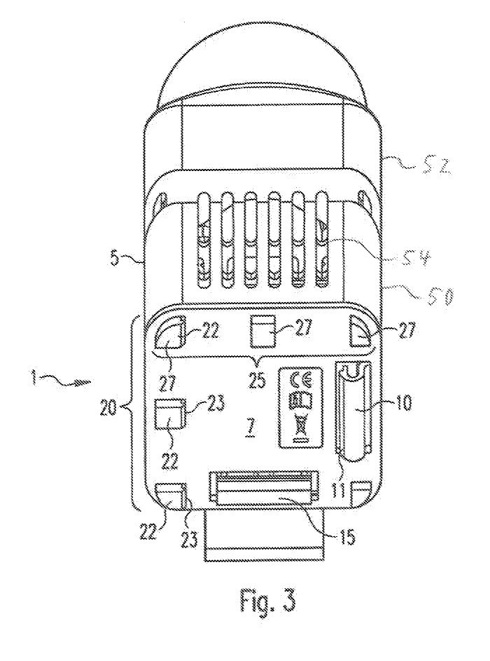

FIG. 3 shows a further perspective view of the rear wall of FIG. 1 or FIG. 2;

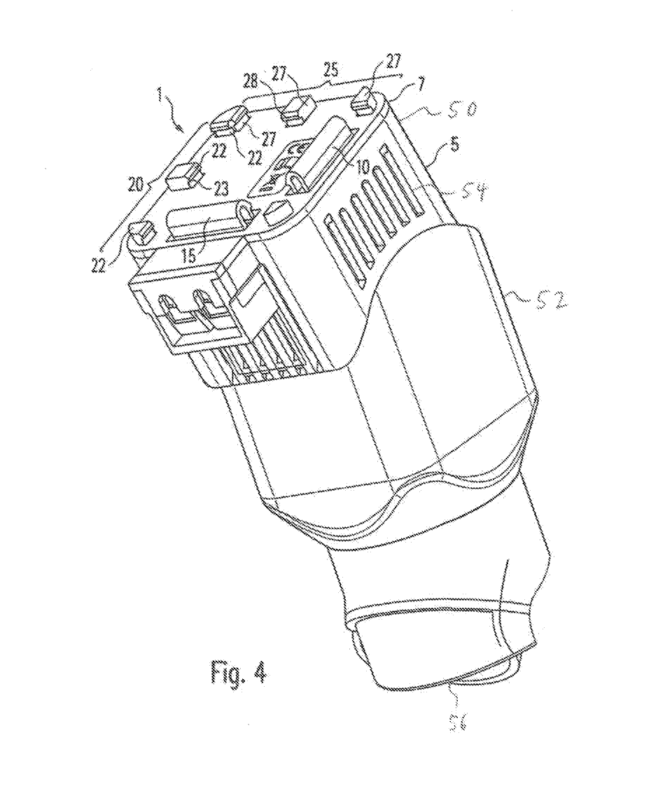

FIG. 4 shows a further perspective view of the rear wall of FIGS. 1-3;

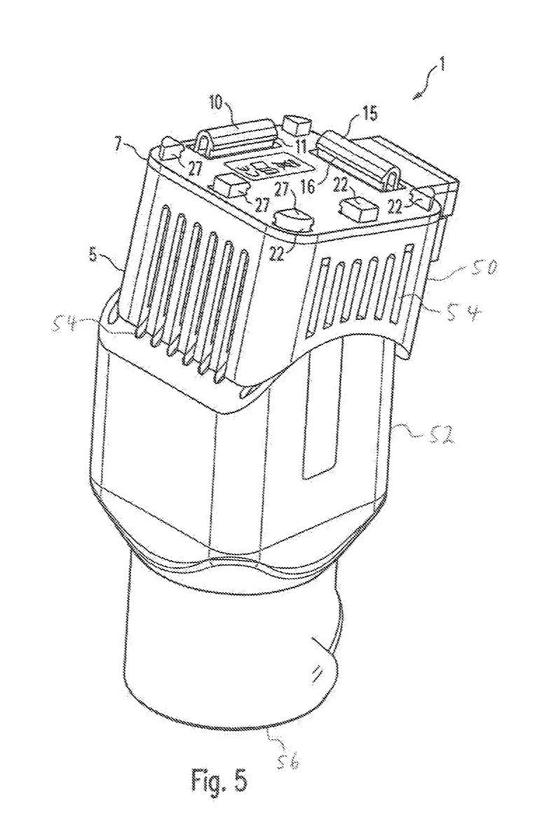

FIG. 5 shows a further perspective view of the rear wall of FIGS. 1-4;

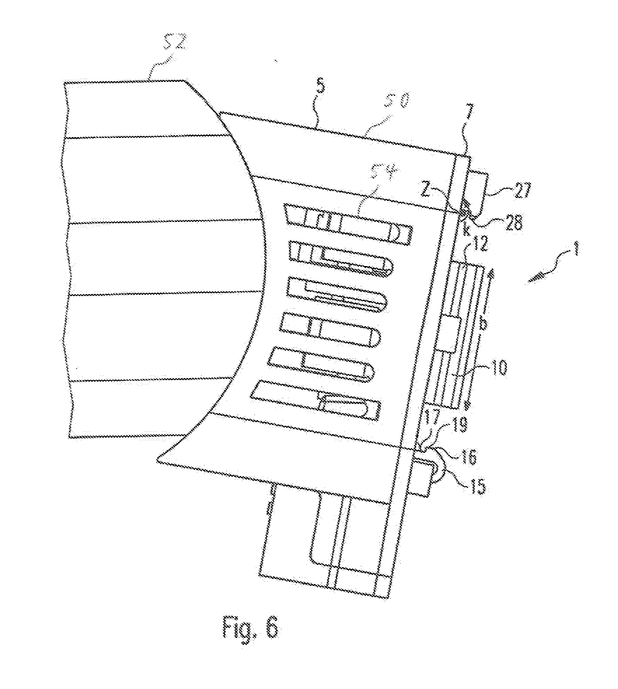

FIG. 6 shows a side view of the rear wall of FIGS. 1-5;

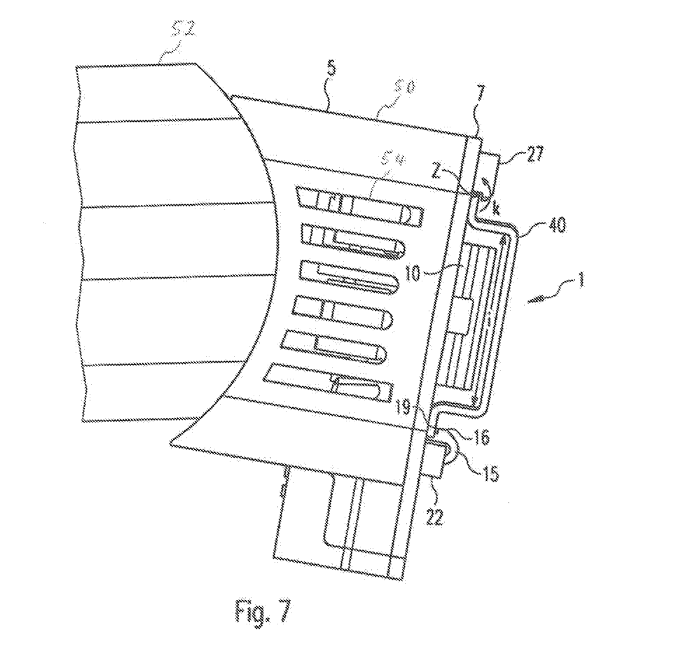

FIG. 7 shows a side view of the rear wall of FIGS. 1-6 with a top-hat rail; and

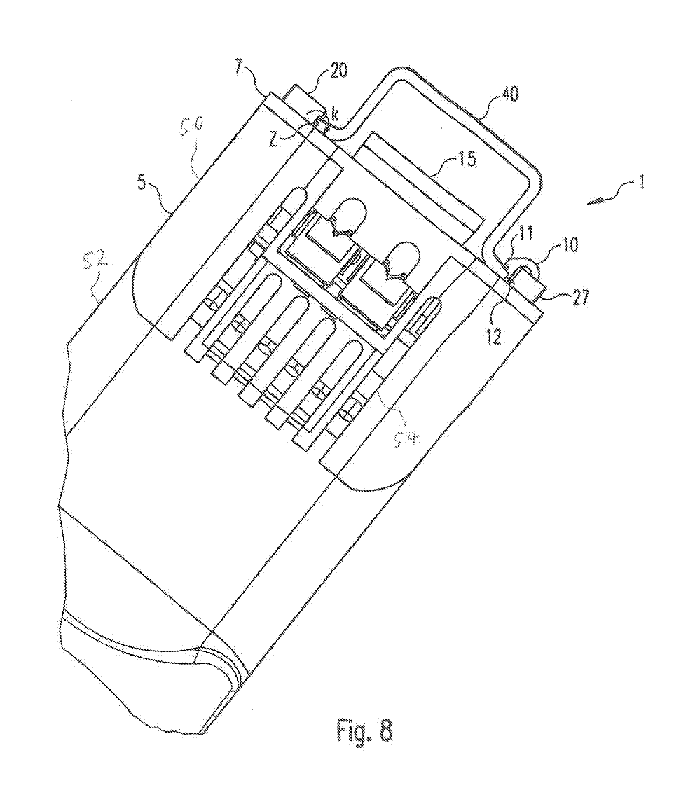

FIG. 8 shows a further side view of the rear wall of FIGS. 1-6 with a further top-hat rail, the first upper and the first lower holding device being used.

In the following description, the same reference numerals are used for identical parts and parts having the same effect.

FIG. 1 shows a top view of a rear wall 7 of an apparatus 5 or body with an embodiment of the fastening device 1 according to the invention. FIG. 2 to FIG. 5 show perspective views of this rear wall 7 of the apparatus 5 with the embodiment of the fastening device 1 according to the invention. The fastening device 1 comprises a first upper holding device 10, a second upper holding device 15, a first lower holding device 20 and a second lower holding device 25. The first holding device 10 is arranged opposite the first lower holding device 20. The second holding device 10 is arranged opposite the second lower holding device 20.

The first upper holding device 10 comprises a snap hook, which is resilient or spring-like. The snap hook 10 (as a flexible component) is fastened to the rear wall 7 of the body 5. It is also conceivable for the snap hook 10 to be fastened to a different part of the device 5 or body or connected thereto. The second upper holding device 15 is substantially identical with the first upper holding device 10. The second lower holding device 25 is substantially identical with the first lower holding device 20.

This means that the second upper holding device 15 likewise comprises a spring-like snap hook. It is also conceivable for the first upper holding device 10 and/or the second upper holding device 15 to comprise more than one snap hook, for example two or three snap hooks.

Resiliently arranged on the rear wall 7 means in this context that the snap hook 10, 15 can be moved laterally, that is to say substantially parallel to the rear wall 7, by a slight application of force and is then moved back into its original position again by the spring force of the snap hook 10, 15 itself.

The first upper holding device 10 comprises all the elements of the fastening device 1 that are in contact with/touch a side or an edge of the top-hat rail 40 in the fastened state. This means that all the elements that touch the same edge or side of the top-hat rail 40 are part of the first upper holding device 10. The same is true for the second upper holding device 15. In the embodiment shown in the figures, the first upper holding device 10 or the second upper holding device 15 comprises only one element. However, it is also conceivable for that element to consist of several parts, for example two, three, four or more. In that case, all the elements that are in contact with the same side of the top-hat rail 40 during use or in the fastened state represent the first upper holding device 10 or the second upper holding device 15. This means that, apart from the first upper holding device 10 or the second upper holding device 15, no further elements touch the top-hat rail 40 on the corresponding side, that is to say on the side that is in contact with the first upper holding device 10 or the second upper holding device 15, during use or in the fastened state.

The same is correspondingly true also for the first lower holding device 20 and the second lower holding device 25. Apart from the first lower holding device 20 or the second lower holding device 25, no further element of the fastening device 1 touches the top-hat rail 40 on the side in question during use/in the fastened state.

The first lower holding device 20 comprises three hook-like projections 22. The hook-like projections 22 are arranged on the rear wall 7 at equal distances from one another, so that they are arranged along a straight line (running from top to bottom in FIG. 1). It is also conceivable for the first lower holding device 20 to comprise one, two or more than three hook-like projections. It is also conceivable for the first lower holding device 20 to comprise projections of a different form. The hook-like projections 22 of the first lower holding device 20 and the hook-like projections 27 of the second lower holding device 25 are fixedly, that is to say not resiliently, connected to the rear wall 7 of the apparatus 5.

The hook-like projections 22 each have an upper protruding or projecting edge 23 facing the first upper holding device 10, so that part of the top-hat rail 40, namely the lower edge of the top-hat rail 40, can be received between the protruding edge 23 and the rear wall 7. In the fastened state, the hook-like projections 22 or the protruding/projecting edges 23 engage around the lower edge of the top-hat rail 40.

Between the hook-like projections 22 there are no further inserts or structural elements on the rear wall 7 of the apparatus 5. The first lower holding device 20, that is to say the three hook-like projections 22, or the longitudinal direction of the projections 22, are/is arranged substantially parallel to the longitudinal direction of the first upper holding device 10. The longitudinal direction corresponds in each case to the direction in which the corresponding structural element has the greatest extent. In FIG. 1, the longitudinal direction of the first upper holding device 10 runs from bottom to top; likewise, the longitudinal direction of the first lower holding device runs from bottom to top in FIG. 1. The longitudinal direction of the second upper holding device and of the second lower holding device runs in each case from left to right in FIG. 1.

The snap hook 10 of the first upper holding device has a projection 11, the upper edge of the top-hat rail 40 being received between the projection 11 and the rear wall 7. In this manner, the rear wall 7 of the apparatus 5, or the apparatus 5 itself, is fastened to a top-hat rail 40.

The fastening device 1 has a second lower holding device 25. The second lower holding device 25 is substantially identical with the first lower holding device 20. The second lower holding device 25 also consists of three hook-like projections 27. It is likewise conceivable for the second lower holding device 25 to comprise only one, two or more than three hook-like projections. It is further conceivable for the second lower holding device 25 to comprise projections of a different form. The second lower holding device 25 is formed substantially parallel to the second upper holding device 15. That is to say, the longitudinal direction of the second lower holding device 25 runs parallel to the longitudinal direction of the second upper holding device 15.

The second lower holding device 25 is arranged substantially perpendicular to the first lower holding device 20. This means that the longitudinal direction of the second lower holding device 25, that is to say the direction of the greatest extent of the second lower holding device 25, runs substantially perpendicular to the longitudinal direction of the first lower holding device 20, that is to say perpendicular to the direction of the greatest extent of the first lower holding device 20. The first upper holding device 10 is arranged substantially perpendicular to the second upper holding device 15.

The expressions “upper holding device” and “lower holding device” are not to be interpreted as being limiting but serve merely to provide an unambiguous designation in the embodiment shown in the figures. Naturally, the upper holding device 10, 15 can also engage, in the fastened state on the top-hat rail, around a (lower) edge of the top-hat rail which is located, relative to the bottom or the base, beneath the upper edge of the top-hat rail, around which the lower holding device 20, 25 correspondingly engages.

The second lower holding device 25 comprises part of the first lower holding device 20. One of the hook-like projections 22 of the first lower holding device 20 has two projecting edges 23, 28, which run perpendicular to one another. A first edge 23 of the two edges 23, 28 serves as part of the first lower holding device 20 and the other projecting edge 28 serves as part of the second lower holding device 25. In FIG. 1, the projection that serves the two lower holding devices 20, 25 is therefore marked with the reference numerals 22 and 27. The hook-like projection 22, 27 which is part of both lower holding devices 20, 25 is located in FIG. 1 in the top left of the rear wall 7, that is to say at the point furthest away from the two upper holding devices 10, 15.

By the arrangement and orientation of two upper holding devices 10, 15 and two lower holding devices 20, 25, the first upper holding device 10 being oriented or arranged perpendicular to the first lower holding device 20 and the second upper holding device 15 being oriented or arranged perpendicular to the second lower holding device 25, it is possible to arrange the apparatus 5 in two orientations perpendicular to one another. This means that, by means of the fastening device 1, the apparatus can be arranged on the top-hat rail 40 in a first position and in a second position rotated through 90° relative to the first position. The associated axis of rotation is perpendicular to the rear wall 7 and runs (in FIG. 1) through the mid-point of the rear wall 7. The orientation of the apparatus 5 can thereby be adapted to the given requirements, for example to the space present/available around the top-hat rail 40 or on the top-hat rail 40.

The projecting edges 23, 28 of the hook-like projections 22, 27 of the lower holding devices 20 , 25 each run parallel to the projections 11, 16 of the corresponding snap hooks 10, 15 or of the corresponding upper holding devices 10, 15.

The first upper holding device 10 and/or the first lower holding device 20 and/or the second upper holding device 15 and/or the second lower holding device 25 is/are preferably formed integrally with the rear wall 7 of the apparatus 5. Preferably, the holding devices 10, 15, 20, 25 are made of a plastics material, the plastics material in particular being injection moulded. However, other materials are also conceivable, for example metal or metal alloys. Furthermore, it is also conceivable for the elements of the holding devices 10, 15, 20 25, in particular the two upper holding devices 10, 15, to be screwed, bonded, etc. to the rear wall.

In the fastened state, a first contact surface 12 of the first upper holding device 10 is in direct contact with the top-hat rail 40. This first contact surface 12 runs perpendicular to the rear wall 7. There are no further structural elements or inserts of the second upper holding device 15 along an imaginary prolongation of that first contact surface 12, which extends along the rear wall 7. It is thereby ensured that, when the first upper holding device 10 is used together with the first lower holding device 20 for fastening to the top-hat rail 40, no structural components or elements of the second lower holding device 25 or of the second upper holding device 15 obstruct or prevent the attachment to the top-hat rail 40. The same applies vice versa. That is to say, no structural elements or inserts of the first holding device 10 are arranged along an imaginary prolongation, running substantially along the rear wall 7, of the second contact surface 17 of the second upper holding device 15, which in the attached state is in direct contact with the top-hat rail 40. It is thereby ensured that, when the second upper holding device 15 and the second lower holding device 25 are used for fastening to the top-hat rail 40, no structural elements or elements of the first upper holding device 10 or of the first lower holding device 20 obstruct the top-hat rail 40 or impede or even prevent the attachment.

In general terms: The snap hooks 10, 15 each have a front edge 14, 19. The front edge 10, 15 is in each case the projecting edge facing the corresponding lower holding device 20, 25. The rear wall 7 is free of inserts along an imaginary prolongation of the front edge 14 of the first upper holding device 10 (parallel to the rear wall 7) and along an imaginary prolongation of the front edge 19 of the second upper holding device 15 (parallel to the rear wall 7). A region of the rear wall 7 around that imaginary prolongation of the front edge 14, 19 is also free of inserts. It is thereby ensured that, when the second upper holding device 15 and the second lower holding device 25 are used for fastening to the top-hat rail 40, no structural elements or elements of the first upper holding device 10 or of the first lower holding device 20 obstruct the top-hat rail or impede or even prevent the attachment.

It is thereby ensured that the rear wall 7, or the apparatus 5, can be fastened to the top-hat rail in two positions or arrangements that are offset relative to one another by about 90°. A high degree of variability of the arrangement is accordingly obtained. The rotation through about 90° takes place about an axis which runs perpendicular to the rear wall 7 and which (in FIG. 1) runs through the middle of the rear wall 7. The apparatus 5 can on the one hand be fastened to or arranged on a top-hat rail 40 in such a manner that the (longitudinal direction of the) top-hat rail 40 runs from left to right in FIG. 1. In that position/arrangement, the second upper 15 and the second lower holding device 25 are used for the fastening. In addition, the apparatus 5 can also be fastened to or arranged on a top-hat rail 40 in such a manner that the (longitudinal direction of the) top-hat rail 40 runs from top to bottom in FIG. 1. In that position/arrangement, the first upper 10 and the first lower holding device 20 are used for the fastening.

The spring-like snap hooks 10, 15 each comprise a surface 13, 18 which is immediately adjacent to the projection 11, 16, is open to the rear wall 7 and is curved towards the rear wall 7. On the side of the curved surface 13, 18 opposite the protruding projection 11, 16, the spring-like snap hook 10, 15 is connected to the rear wall 7. As a result, when a force is exerted on the curved surface 13, 18 of the snap hook 10, 15, the snap hook 10, 15 is moved to the side, namely away from the lower holding device 20, 25. As soon as a force ceases to act on the snap hook 10, 15, it moves back into its original position again, which is shown in FIGS. 1-8.

The second upper holding device 15 has a width b which is smaller than the (smallest) distance between the first upper holding device 10 and the first lower holding device 20. The same is true in relation to the first upper holding device 10. This means that the first upper holding device 10 has a length b which is smaller than the distance between the second upper holding device 15 and the second lower holding device 25. It is thereby ensured that, when the first upper holding device 10 and the first lower holding device 20 are used for fastening the apparatus 5 to the top-hat rail 40, the second upper holding device 15 can be received within the inside dimension or in the interior of the top-hat rail 40. The same is true vice versa, that is to say when the second upper holding device 15 and the second lower holding device 25 are used for fastening the apparatus 5 to the top-hat rail 40, the first upper holding device 10 is received within the inside dimension/interior of the top-hat rail 40.

The entirety of the second upper holding device 15 is thereby received within the inside dimension or the interior of the top-hat rail 40; that is to say, when the first upper holding device 10 and the first lower holding device 20 are used for fastening the apparatus 5 to the top-hat rail 40, no element of the second upper holding device 15 is located outside the interior of the top-hat rail 40. All the elements of the fastening device 1 which touch a first side of the top-hat rail 40 in the fastening arrangement rotated through 90° (that is to say the entirety of the second upper holding device 15) are located in the interior of the top-hat rail 40 in the second fastening arrangement.

The same is correspondingly true vice versa, that is to say the “roles” of the first holding devices 10, 20 and of the second holding devices 15, 20 are correspondingly reversed when the second upper holding device 15 and the second lower holding device 25 are used for fastening the apparatus 5 to the top-hat rail 40.

The fastening device 1 has mirror symmetry with respect to a plane of symmetry S which runs perpendicular to the plane of the paper in FIG. 1 and centrally through the hook-like projection 27 shown on the top left in FIG. 1 and centrally through the projection (without a reference numeral) shown in the bottom right of FIG. 1.

In FIG. 1, the mirror plane or plane of symmetry S accordingly runs perpendicular to the plane of the paper and from top left to bottom right at an angle of 45° to the longitudinal direction of the first upper holding device 10 and likewise at an angle of 45° to the longitudinal direction of the second upper holding device 15. All the elements of the fastening device 1 are substantially mirror symmetrical with respect to that plane of symmetry or mirror plane S.

FIG. 6 shows a side view of the rear wall 7 and of the embodiment of the fastening device 1 of FIG. 1-5. In FIG. 6, the tilt axis Z is shown. The tilt axis Z is located on the rear wall 7 or at the rear wall 7 and on the side of the hook-like projection 27 facing the second holding device 15. The tilt axis Z runs along the rear wall 7. In order to fasten the apparatus, the fastening device 1 is placed on the top-hat rail 40 in such a manner that the lower edge of the top-hat rail 40 is received beneath the projecting edge 28 of the hook-like projections 27. The apparatus 5, or the rear wall 7 together with the apparatus 5, is then rotated about the tilt axis Z in the direction of the tilt direction k; this is anti-clockwise in FIG. 6. As a result of tilting or pivoting in the tilt direction k, the spring-like snap hook 15, or the curved part/curved surface 18 of the snap hook 15, comes into direct contact with the top-hat rail 40. Owing to the curved shape of the surface 18 of the snap hook 15, the snap hook 15 is pressed away from the hook-like projections 27 (substantially downwards in FIG. 6). As the body 5 or the rear wall 7 is tilted further, the top-hat rail 40 is then able to come into direct contact with the second contact surface 17. As soon as the top-hat rail 40 has passed the projection 16 of the snap hook 15 or the front edge 19 of the snap hook 15, the snap hook 15 moves back into the original position shown in the figures. The snap hook 15 then engages around the upper edge of the top-hat rail 40. The rear wall 7 of the body 5 is accordingly fastened to the top-hat rail 40. The fastened state is shown in FIG. 7.

The top-hat rail 40 is released by pressing the spring-like snap hook 15 away from the hook-like projections 27 again, as a result of which the rear wall 7 of the apparatus 5 and accordingly the apparatus 5 itself is released from the top-hat rail 40 again by tilting in the opposite direction to the tilt direction k about the tilt axis Z.

In FIG. 7, the rear wall 7 of the apparatus 5 is shown in the fastened state on the top-hat rail 40, which has an inside dimension i. It can clearly be seen in FIG. 7 that the first upper holding device 10 is received in the inside dimension i of the top-hat rail 40, or in the interior of the top-hat rail 40. It can also clearly be seen in FIG. 7 that the second contact surface 17 of the second upper holding device 15, or a prolongation thereof, projects in relation to the top-hat rail 40 relative to the hook-like projections 22 of the first lower holding device 20 that are not in use in FIG. 7. In general terms: The rear wall 7 is free of inserts along an imaginary prolongation of the front edge 19 of the second upper holding device/of the snap hook 15 (along the rear wall 7). The hook-like projection 22 of the first lower holding device 20, which is to be seen in FIG. 7, is set back relative to the front edge 19, or the imaginary prolongation of the front edge 19, that is to say the hook-like projection 22, which is to be seen in FIG. 7, is at a greater distance from the hook-like projection 27 of the second lower holding device 25, which is to be seen in FIG. 7, than the second upper holding device 15, or the front edge 19 of the second upper holding device 15. Elements of the first lower holding device 20 and of the first upper holding device 10 accordingly do not prevent attachment or fastening by means of the second upper holding device 15 and the second lower holding device 25.

FIG. 8 shows a further side view of the rear wall 7 of the apparatus 5 and the fastening device 1, wherein the first upper holding device 10 and the first lower holding device 20 are used for the fastening. In FIG. 8, the tilt axis Z is at the point at which the side of the first lower holding device 20 facing the upper holding device 10 touches the rear wall 7. The tilt axis runs along the rear wall 7. The tilt direction k runs clockwise in FIG. 8. The top-hat rail 40 in FIG. 8 has a greater height than the top-hat rail 40 in FIG. 7. The tilt axis Z in FIG. 8 runs perpendicular or substantially perpendicular to the tilt axis Z in FIG. 6 and FIG. 7. The two arrangements shown in FIG. 7 and FIG. 8 are rotated through 90° relative to one another.

It can clearly be seen in FIG. 8 too that the first contact surface 12 of the first upper holding device 10 is arranged closer to the first lower holding device 20 than the hook-like projections 27 of the second lower holding device 25. It can also clearly be seen in FIG. 8 that the hook-like projection 27 is set back relative to the first upper holding device 10, that is to say is at a greater distance from the first lower holding device 20 than the first upper holding device 10, or the front edge 14 of the first upper holding device 10. As a result, these, that is to say the components or inserts of the second lower holding device 25, do not prevent the use of the first upper holding device 10 for fastening the rear wall 7 of the apparatus 5 to the top-hat rail 40.

The apparatus to be fastened can in particular be a fan. The fan has a nozzle 52. The nozzle 52 is a movable nozzle with which the direction of the air stream emerging from the fan nozzle 52 can be directed. The nozzle 52 is pivotable about an axis which in the fastened state runs parallel to the longitudinal axis of the top-hat rail 40 (not shown). The nozzle 52 is fastened to a base plate 50. The connection between the nozzle 52 and the base plate 50 is made by a one-dimensional pivot element or pivot joint known per se (not shown). A one-dimensional pivot element is pivotable in a single pivot plane.

The convex rear wall of the nozzle 52 is received in a correspondingly concave front wall of the base plate 50. The side walls of the base plate 50 have air slots 54. Further air slots are provided in the front wall of the base plate 50 and in the rear wall of the nozzle 52. Components known per se can be used for the nozzle 52 and the base plate 50, the rear wall 7 of the base plate 50 having the actual fastening device 1.

The fan comprises a discharge grid 56, which is arranged on the side of the fan 52 remote from the rear wall. The air flows through the discharge grid 56. The discharge grid 56 can be rotated about an axis which runs substantially parallel to the longitudinal axis of the fan. The outflow direction of the air can be correspondingly changed or adjusted thereby.

### LIST OF REFERENCE NUMERALS

1 fastening device
5 apparatus
7 rear wall
10 first upper holding device (snap hook)
11 projection of the snap hook (first upper holding device)
12 first contact surface
13 curved surface (first upper holding device)
14 front edge of the first upper holding device
15 second upper holding device (snap hook)
16 projection of the snap hook (second upper holding device)
17 second contact surface
18 curved surface (second upper holding device)
19 front edge of the second upper holding device
20 first lower holding device
22 hook-like projection (first lower holding device)
23 projecting edges of the hook-like projections (first lower holding device)
25 second lower holding device
27 hook-like projection (second lower holding device)
28 projecting edges of the hook-like projections (second lower holding device)
40 top-hat rail
50 base plate
52 nozzle
54 air slot
56 discharge grid
i inside dimension top-hat rail
b width of the snap hooks
Z tilt axis
k tilt direction
S mirror plane/plane of symmetry

1.-11. (canceled)

12. A fastening device for fastening an apparatus or a body by means of its rear wall to a top-hat rail, comprising a first upper holding device and a first lower holding device, the first upper holding device engaging around an upper edge of the top-hat rail in the fastened state and the first lower holding device engaging around a lower edge of the top-hat rail in the fastened state, wherein the first upper holding device is in a resilient form such that the apparatus or the body can be inserted into the top-hat rail by being tilted in an insertion tilt direction about a tilt axis running parallel to the longitudinal direction of the top-hat rail.

13. The fastening device of claim 12, wherein the first upper holding device is connected to the rear wall.

14. The fastening device of claim 12, wherein the fastening device is connected directly to the rear wall.

15. The fastening device of claim 12, wherein the fastening device further comprises a second upper holding device and a second lower holding device, the second upper holding device being substantially identical with the first upper holding device and the second lower holding device being substantially identical with the first lower holding device.

16. The fastening device of claim 15, wherein the second upper holding device is arranged substantially perpendicular to the first upper holding device and the second lower holding device is arranged substantially perpendicular to the first lower holding device.

17. The fastening device of claim 15, wherein the first and/or the second upper holding device comprises a spring-like snap hook.

18. The fastening device of claim 12, wherein the first upper holding device comprises a spring-like snap hook.

19. The fastening device of claim 15, wherein at least one of the second upper holding device and the second lower holding device is integral with the rear wall of the apparatus or with the body.

20. The fastening device of claim 12, wherein at least one of the first upper holding device and the first lower holding device is integral with the rear wall of the apparatus or with the body.

21. The fastening device of claim 19, wherein at least one of the first upper holding device, the first lower holding device, the second upper holding device, and the second lower holding device are made of a plastics material.

22. The fastening device according to claim 15, wherein the first upper holding device has a width which is smaller than the distance between the second upper holding device and the second lower holding device, and/or the second upper holding device has a width which is smaller than the distance between the first upper holding device and the first lower holding device.

23. The fastening device of claim 15, wherein the rear wall is free of inserts along an imaginary prolongation of a front edge of the first upper holding device and along an imaginary prolongation of a front edge of the second upper holding device.

24. The fastening device of claim 15, wherein the first lower holding device and/or the second lower holding device comprise three hook-like projections.

25. The fastening device of claim 12, wherein the first lower holding device comprises three hook-like projections.

26. The fastening device of claim 15, wherein the first lower holding device and/or the second lower holding device comprises three hook-like projections which particular are at equal distances from one another.

27. The fastening device of claim 15, wherein the second lower holding device comprises part of the first lower holding device.

28. An arrangement comprising an apparatus or a body and a top-hat rail, the apparatus or the body being fastened to the top-hat rail by means of a fastening device of claim 12.

29. An arrangement comprising an apparatus or a body and a top-hat rail, the apparatus or the body being fastened to the top-hat rail by means of a fastening device of claim 15.
